(19) United States
(12) Patent Application Publication
(10) Pub. No.: US 2017/0210266 A1
(43) Pub. Date: Jul. 27, 2017

(54) EJECTOR CONTROL FOR SPREADING MATERIAL

(71) Applicant: Deere & Company, Moline, IL (US)

(72) Inventors: Douglas G. Meyer, DUBUQUE, IA (US); Francois Stander, DUBUQUE, IA (US)

(21) Appl. No.: 15/006,369

(22) Filed: Jan. 26, 2016

(51) Int. Cl. B60P 1/00; B60P 3/00

(52) U.S. Cl. CPC B60P 1/006; B60P 3/00

(57) ABSTRACT

In accordance with an example embodiment, a method of operating a work vehicle with an ejector body may include the steps of receiving a target parameter at a controller indicative of at least one of a target distance over which to spread a load of material from the ejector body onto a ground surface and a target thickness at which to spread the material from the ejector body onto the ground surface, entering a controller into an ejection mode, and controlling, with the controller, in the ejection mode, at least one of a speed of the work vehicle and a speed of an ejector included in the ejector body, to spread the material based on the target parameter.

### TECHNICAL FIELD

The present disclosure generally relates to a machine and a method. An embodiment of the present disclosure relates to a control system and method of control for a work vehicle with an ejector body.

### BACKGROUND

Work vehicles may include beds or bins for hauling material, such as dirt, rock, sand, or other materials. The beds of these work vehicles may be unloaded (emptied) of the hauled material in different manners, including by tipping the bed to slide the material out, opening doors along the bottom of the bed so that the material may flow out, or operating an ejector mechanism which pushes the material out of the bed. These beds may also include tailgates to selectively close off an exit to the bed so as to retain material.

One example of a work vehicle with an ejector mechanism may be an articulated dump truck. Material may be loaded into a bed positioned on a rear frame of the truck at a first site, hauled by the truck to a second site, and unloaded at the second site. The material may be loaded into the truck by an excavator and unloaded from the truck by the movement of a headboard which pushes the material out of the bed of the truck.

### SUMMARY

Various aspects of examples of the present disclosure are set out in the claims.

According to an aspect of the present disclosure, a method of operating a work vehicle with an ejector body may include the steps of receiving a target parameter at a controller indicative of at least one of a target distance over which to spread a load of material from the ejector body onto a ground surface and a target thickness at which to spread the material from the ejector body onto the ground surface, entering a controller into an ejection mode, and controlling, with the controller, in the ejection mode, at least one of a speed of the work vehicle and a speed of an ejector included in the ejector body, to spread the material based on the target parameter.

According to another aspect of the present disclosure, the speed of the work vehicle may be controlled based on the target distance and the speed of the ejector.

According to another aspect of the present disclosure, the speed of the ejector may be controlled based on the target distance and the speed of the work vehicle

According to another aspect of the present disclosure, the speed of the work vehicle may be controlled based on the target thickness and the speed of the ejector.

According to another aspect of the present disclosure, the speed of the ejector may be controlled based on the target thickness and the speed of the work vehicle.

According to another aspect of the present disclosure, the controller may enter into the ejection mode based on an ejection command received from an input actuated by an operator of the work vehicle.

According to another aspect of the present disclosure, the method may include receiving a position signal indicative of a position of the work vehicle, determining a first position based on the position signal upon receiving a first input from an operator of the work vehicle, determining a second position based on the position signal upon receiving a second input from the operator of the work vehicle, and determining the target parameter based on a comparison of the first position and the second position.

According to another aspect of the present disclosure, may include the step of receiving a position signal indicative of a position of the work vehicle and the controller entering into the ejection mode based on a comparison of the position signal and a first position.

According to another aspect of the present disclosure, the method may include the steps of determining the first position based on the position signal upon receiving a first input from an operator of the work vehicle, determining a second position based on the position signal upon receiving a second input from the operator of the work vehicle, and determining the target parameter based on a comparison of the first position and the second position.

According to another aspect of the present disclosure, the method may include the step of limiting a maximum speed of the work vehicle, prior to entering the controller into the ejection mode, based on a comparison of the position signal and the first position.

According to another aspect of the present disclosure, the maximum speed may be based on the target parameter.

According to another aspect of the present disclosure, a work vehicle with an ejector body may include an engine, a transmission, an ejector connected to the ejector body and movable by an actuator at an ejector speed between a retracted position and an extended position, and a controller. The controller may be configured to receive a target parameter indicative of at least one of a target distance and a target spreading thickness, receive a speed signal indicative of a speed of the work vehicle, enter an ejection mode, and control, in the ejection mode, at least one of a speed of the engine, a gear selection of the transmission, and the ejector speed based on the target parameter to spread a load of material from the ejector body onto a ground surface.

According to another aspect of the present disclosure, the work vehicle may also include a first operator input configured to provide the target parameter, a second operator input configured to provide an ejection command when actuated, and a vehicle speed sensor configured to provide the speed signal. The controller may be configured to receive the ejection command and enter the ejection mode based on the ejection command.

According to another aspect of the present disclosure, the controller may be configured to control, in the ejection mode, the ejector speed based on the target parameter and the speed signal.

According to another aspect of the present disclosure, the controller may be further configured to control, in the ejection mode, the speed of the engine based on the target parameter.

According to another aspect of the present disclosure, the positioning system receiver may be configured to provide a position signal indicative of a position of the work vehicle, and the controller may be further configured to receive the position signal and enter the ejection mode based on a comparison of the position signal and a first position.

According to another aspect of the present disclosure, the work vehicle may include a positioning system receiver configured to provide a position signal indicative of a position of the work vehicle. The controller may be further configured to receive the position signal, determine the first position based on the position signal when the second operator input is actuated and held for a period of time, and enter the ejection mode based on a comparison of the position signal and a first position.

According to another aspect of the present disclosure, the work vehicle may include a positioning system receiver configured to provide a position signal indicative of a position of the work vehicle. The controller may be further configured to receive the position signal, determine a first position based on the position signal and a first actuation of the second operator input, determine a second position based on the position signal and a second actuation of the second operator input, and determine the target parameter based on a comparison of the first position and the second position.

According to another aspect of the present disclosure, the controller may enter the ejection mode upon receiving the ejection command for less than a period of time, the first actuation may be actuating the second operator input from a neutral position to a depressed position for at least the period of time, and the second actuation may be actuating, after the first actuation, the second operator input from a neutral position to a depressed position for at least the period of time.

According to another aspect of the present disclosure, the controller may enter the ejection mode upon receiving the ejection command for less than a period of time, the first actuation may be actuating the second operator input from a neutral position to a depressed position for at least the period of time, and the second actuation may be actuating the second operator input from the depressed position to the neutral position after the first actuation.

The above and other features will become apparent from the following description and accompanying drawings.

### BRIEF DESCRIPTION OF THE DRAWINGS

The detailed description of the drawings refers to the accompanying figures in which:

FIG. 1 is a left side view of a work vehicle with an ejector body performing a material spreading operation;

FIG. 2 is a flowchart of a system and method for ejecting material from the work vehicle;

FIG. 3 is a flowchart of a first alternative system and method for ejecting material from the work vehicle;

FIG. 4 is a flowchart of a second alternative system and method for ejecting material from the work vehicle;

FIG. 5 is a flowchart of a third alternative system and method for ejecting material from the work vehicle;

FIG. 6 is a flowchart of a fourth alternative system and method for ejecting material from the work vehicle;

FIG. 7 is a flowchart of a fifth alternative system and method for ejecting material from the work vehicle;

FIG. 8 is a flowchart of a sixth alternative system and method for ejecting material from the work vehicle; and

FIG. 9 is a flowchart of a seventh alternative system and method for ejecting material from the work vehicle.

Like reference numerals are used to indicate like elements throughout the several figures.

### DETAILED DESCRIPTION

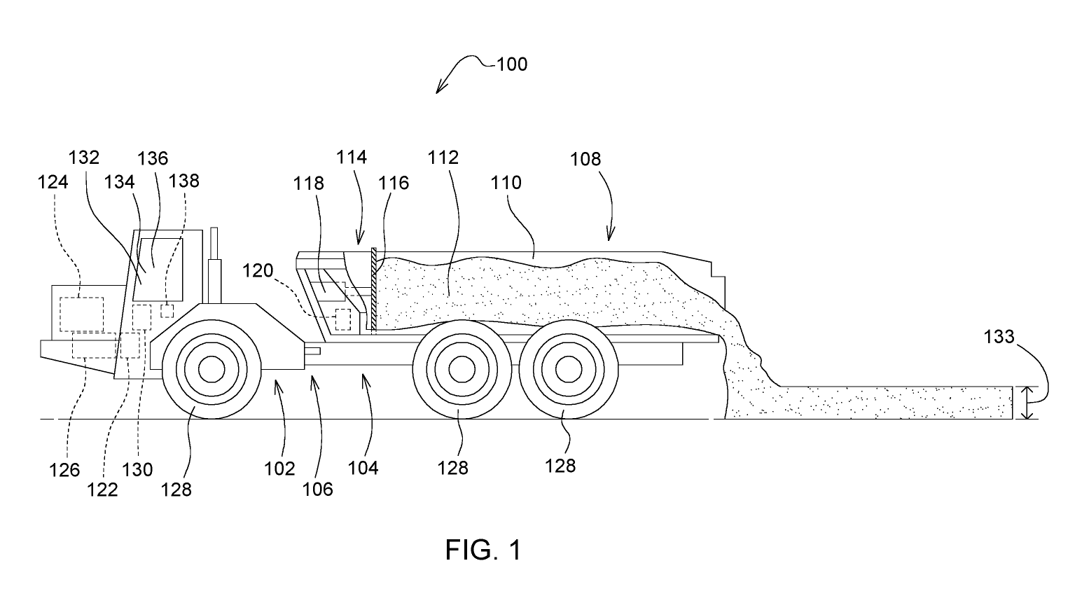

FIG. 1 illustrates an articulated dump truck 100, or ADT. ADT 100 includes a front frame 102 which is connected to a rear frame 104 via an articulation joint 106 which allows the front frame 102 to move relative to the rear frame 104 with multiple degrees of freedom to better enable the ADT 100 to traverse rough and uneven surfaces.

ADT 100 includes an ejector body 108 which is positioned on, or is integrally formed with, the rear frame 104. The ejector body 108 includes a bin 110 for holding a payload (or load), such as material 112. Although the term “bin” is used herein, the bin 110 could be any type of load-carrying body.

The ejector body 108 also includes an ejection system 114 which can selectively eject the payload from the bin 110 onto the ground behind the ADT 100. The ejection system 114 is positioned toward the front of the ejector body 108, and includes an ejector 116, which may also be referred to as a headboard, and an actuator 118. The ejection system 114 operates by having the actuator 118 move the ejector 116 rearward to force material out the rear end of the bin 110.

The ejector 116 may be supported, aligned, and oriented during this motion by a retention assembly within the bin 110. The retention assembly may be, for example, a set of guides which receive protrusions from the ejector 106, and the cooperation of the ejector 106 with these guides may keep the ejector 106 properly aligned and oriented during its movement in the bin 110. The actuator 118 is a double-acting telescoping hydraulic cylinder, but in alternative embodiments may include a non-telescoping hydraulic cylinder, a hydraulic motor, a screw or worm gear, chains, cables, or an electric motor or actuator, either alone or in combination with each other. While an articulated dump truck is illustrated in FIG. 1, the present disclosure is not limited to such a machine form and could include other machine forms with an ejector system, such as a scraper, rigid frame dump truck, on-road dump truck, or rail car.

The actuator 118 is controlled by the flow of hydraulic fluid from an electro-hydraulic valve 120. The electro-hydraulic valve 120 receives pressurized hydraulic fluid from a hydraulic pump 122, which is rotationally coupled to, and powered by, an engine 124 via a transmission 126. Alternatively, the hydraulic pump 122 may be directly powered by the engine 124 without an intermediate transmission. Engine 124 is disposed on the front frame 102 and powers ADT 100, including providing tractive effort delivered through transmission 126 and ground-engaging wheels 128. Transmission 126 may provide multiple speed ratios through which the engine 124 may drive the wheels 128. Examples of such transmissions include multiple gear transmissions, hydrostatic transmissions, continuously variable transmissions or infinitely variable transmission (CVT or IVT), and electrical transmissions (e.g., generator and motors). Controlling the speed ratio of the transmission 126 may achieve multiple goals, including optimizing the power output of the engine 124, maximizing the efficiency of the engine 124, managing the rotational speed of the engine 124, and managing the groundspeed of the ADT 100.

The groundspeed, or speed, of the ADT 100 is measured by vehicle speed sensor 130, which senses the rotational speed of the drivetrain output of the transmission 126 and provides a signal indicative of that rotational speed. Alternatively, the speed of the ADT 100 may be measured by a rotational speed sensor placed at another portion of the drivetrain of the ADT 100, for example on one or more wheels, before or after a differential, on the input shaft to the transmission 126, on another output shaft of the transmission 126, or on an output shaft of the engine 124. In all these alternatives, the vehicle speed sensor provides a signal indicative of a speed of the ADT 100, but, depending on where such sensor is placed, the signal it provides may require further processing to arrive at the speed of the ADT 100. The signal may need to be adjusted to reflect the overall effective speed ratio between the sensor's location and the wheels and the diameter of the wheels, and may require the gathering of other variables such as the current speed ratio of the transmission 126, the state or operating parameter of a differential, or parameters indicative of rotational slippage between the sensor's location and the ground. In yet other alternatives, the speed of the ADT 100 may be measured by ground-sensing radar, calculated based on the optical flow from a camera input, or calculated based on signals received from a positioning system (e.g., Global Navigation Satellite System such as GPS or GLONASS, adaptive GPS, local positioning system, cellular positioning system, combinations of these).

The speed of the ADT 100 may be displayed on a monitor 132 located within an operator station mounted to the front frame 102. The monitor 132 may also display other information such as the gear of the transmission 126, the weight of the payload (load) being hauled by the ADT 100, or the state of the ejector bed 108 or the ejector 116 (e.g., fully retracted, extending, fully extended, retracting). The monitor 132 may also be interactive, and enable an operator of the ADT 100 to edit settings or parameters associated with the ADT 100 through buttons, a touchscreen, or peripherals in communication with the monitor 132.

The operator may enter a target parameter into the monitor 132 for the operation of the ADT 100. The target parameter may indicate a target distance over which the operator desires to spread the load being hauled by ADT 100 or it may indicate a target thickness at which the operator desires to spread the load being hauled by the ADT 100 onto the ground, such as a thickness 133. Alternatively, such a target parameter may be input remotely, such as by an owner, site manager, fleet manager, or other work vehicle at the work site, and communicated to the ADT 100 through a wireless signal, such as via a cellular or satellite communications network. Spreading the load of the ADT 100 over an area based on a target parameter may improve the efficiency of the work site by more carefully managing the material being hauled by the ADT 100. For example, spreading the material over a target distance may help keep the hauled material in an unloading zone which may avoid the need for later rework to bring the material into the unloading zone. As another example, spreading the material at a target thickness may help keep a uniform unloading zone which may reduce or avoid the need for later work operations to level the unloading zone. By contrast, a haul vehicle which unevenly dumps its load, or dumps its load all in one place, may require a crawler-dozer, motor grader, or both to knock down and flatten the hauled dirt after the haul vehicle has completed its operations, which may add time and cost to a job.

The operator may also utilize the monitor 132 to trigger the recording or storing of positional information of the ADT 100. When the ADT 100 is at a particular position that the operator wishes to record, for example a position or area at which the operator wishes to start an unloading process of the ADT 100, the operator may actuate an input on the monitor 132 to request that the current position be recorded. Similarly, when the ADT 100 is at a position or area which the operator wishes to record as an end point for the unloading process of the ADT 100, the operator may actuate an input on the monitor 132 to request that the current position be recorded. The actuations to record the start position and the end position may vary depending on the design of the ADT 100, including having the same actuation of the same input (e.g., a first actuation records a start position, a second actuation after the first actuation records an end position), a different actuation of the same input (e.g., a momentary actuation records a start position, a long-press actuation records an end position), or an actuation of two different inputs (e.g., actuating a first button records a start position, actuating a second button records an end position). Alternatively, the operator may actuate an input not associated with the monitor 132 to trigger the recording of positional information of the ADT 100. For example, the operator may actuate buttons/switches, dials, levers, or other touchscreens in the operator station.

The operator may control the ADT 100 through a combination of operator inputs located inside the operator station, such as throttle and brake pedals and lever 134. Lever 134 may be actuated to control the ejector 116, and in this embodiment the actuation position of the lever 134 may control the speed at which the ejector 116 moves. Actuation of the lever 134 in a first direction may cause the ejector 116 to move rearwards and unload material from the bin 110, while actuation of the lever 134 in a second direction may cause the ejector 116 to move forwards and prepare the bin 110 to receive another load of material.

The operator may also control the ejector 116 through the switch 136. In this embodiment, switch 136 is a button positioned on the lever 134, but in other embodiments it may be a detent of the lever 134 (e.g., actuating the lever 134 beyond a certain position may serve the same function as actuating the switch 136), or a user input elsewhere in the operator station. When the operator actuates the switch 136, it may activate an automated or semi-automated ejection mode for the ADT 100 in which the ejector 116 unloads the material in the bin 110. Optionally, this automated ejection mode may include returning the ejector 116 to its forward position at the end of the cycle so the ADT 100 is prepared to accept another load of material in the bin 110.

A controller 138 is provided on the ADT 100. The controller 138 is in communication with each of the electro-hydraulic valve 120, engine 124, transmission 126, vehicle speed sensor 130, monitor 132, lever 134, and switch 136. Controller 138 may control the electro-hydraulic valve 120 to control the flow of hydraulic fluid from the hydraulic pump 122 to the actuator 118, and thereby control the speed of the ejector 116. Controller 138 may receive signals indicative of parameters of the engine 124, such as those relating to rotational speed (speed), torque, and power, and may control certain aspects of the operation of the engine 124, such as rotational speed, torque, and power. Controller 138 may communicate with the engine 124 through intermediate components, such as an engine control unit (ECU), and thus may control the engine 124 indirectly by sending commands to the ECU, which in turn controls the engine 124. Similarly, controller 138 may receive signals indicative of rotational speed, gear or speed ratio, torque, and power of the transmission 126, and may control certain aspects of the operation of the transmission 126, including through an intermediate component such as a transmission control unit (TCU). As an example, the controller 138 may control the gear or range selection of the transmission 126, or may control a retarder of the transmission 126 to slow the ADT 100.

The controller 138 may receive a speed signal from the vehicle speed sensor 130 indicative of a speed of the ADT 100. The speed signal may be communicated in any of a number of different formats, such a voltage signal, a current signal, a pulse or count signal, or a message such as a controller area network (CAN) message. Depending on the nature of the speed signal, the controller 138 may have to further process the signal to determine an estimated speed of the ADT 100, such as by looking up a speed value in a table which correlates the speed signal to actual speed, adjusting the speed signal by constants such as the speed ratio of differentials or other drivetrain components, or by utilizing the speed signal in a multiple variable equation involving other variables such as transmission gear and slip ratios to determine speed.

The controller 138 may also receive position information from a positioning system, such as via communication with a positioning system 137, such as a GNSS receiver. Alternative positioning systems including local positioning systems utilizing signals from multiple local transmitters to determine position, cellular positioning systems which utilize signals from local cellular towers to determine position, and adaptive positioning systems which utilize signals from multiple different positioning systems to determine position more accurately than a single system could provide (e.g., utilizing GNSS and refining the signal with local transmitters or cellular signals). The controller 138 may utilize this position information when recording start and end positions for an unloading process, or it may utilize this position information to initiate and terminate an unloading process automatically when the ADT 100 reaches a start or end position.

The controller 138 may also communicate with another controller located on the ADT 100 or through a cellular or satellite communication system to a controller located remotely, such as a server or a device operated by a remote owner, operator, or fleet manager. Communication with such controllers may be utilized to set certain parameters of the controller 138, such as the start and end positions for an unloading process or a target parameter (distance or thickness), or for the controller 138 to report out parameters of the operation of the ADT 100, such as the payloads hauled, the route taken, the areas which received unloaded material.

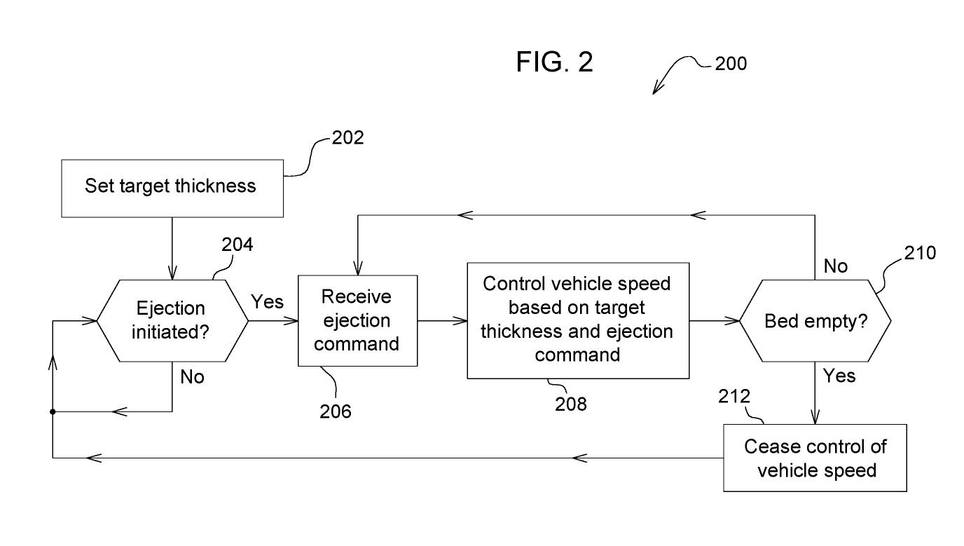

FIG. 2 illustrates a flowchart of a control system 200 that the controller 138 may execute in order to spread material at an unloading area based on a target thickness. In step 202, the controller 138 receives a target thickness. The controller 138 may set this thickness based on a target parameter received indicative of such a thickness, such as a signal received from the monitor 132 after the operator has entered a target thickness or a signal received from a remote server. In step 204, the controller 138 determines whether an ejection has been initiated. In control system 200, the controller 138 performs this step by determining whether it has received an ejection command from an operator. For the control system 200, the ejection is initiated when the operator actuates the lever 134 in a direction which indicates that the ejector 116 should eject material from the bin 110. In alternate embodiments, an operator may actuate the switch 136 in order to give such an ejection command. In yet other alternate embodiments, the controller 138 may generate or provide the ejection command to itself, and in such embodiments the controller 138 is still said to receive such an ejection command, even if the ejection command was generated within the controller 138 and was never communicated external to the controller 138. If the controller 138 receives an ejection command, it enters an ejection mode and proceeds to step 206 to perform the unloading process of steps 206, 208, 210, and 212. If the controller 138 does not receive an ejection command, it loops step 204 until it does receive such a command.

In step 206, the controller 138 receives the ejection command which indicates a commanded speed for the ejector 116. In the control system 200, the controller 138 receives a signal from the lever 134 which indicates a desired speed for the ejector 116 which depends on the degree of actuation of the lever. If the lever 134 is fully actuated in the ejection direction, the ejector 116 is commanded to its maximum ejection speed. Alternatively, the controller 138 may receive the ejection command from another source, such as a value stored in memory or a value received from a remote controller or device and communicated over a satellite or cellular communication system. The controller 138 then controls the speed of the ejector 116, via the electro-hydraulic valve 120, based on the received ejection command. As used herein, the “speed” of the ejector references a linear speed such as 1 meter per second, but can also reference a cycle time such as 10 seconds although adjustments would need to be made in how the speed is utilized in calculations and determinations.

The controller 138 performs step 208 next by controlling the speed of the ADT 100 (to a control speed) based on the target thickness received in step 202 and the ejection command received in step 206. The controller 138 may control the speed of the ADT 100 by, for example, controlling a speed, torque, or power of the engine 124, a rotational speed, gear or speed ratio, power, or torque of the transmission 126, a retarder connected to the drivetrain and designed to controllably slow the drivetrain, an engine brake, service brakes, or a combination of these. For example, the controller 138 may control the speed of the ADT 100 by limiting the maximum speed of the engine 124 and controlling which gear/speed ratio may be utilized for the transmission 126. Such control may not always achieve the target thickness, for example if the operator of the ADT 100 does not actuate the throttle pedal far enough to bring the ADT 100 to the maximum speed, the speed of the ADT 100 will fall below the control speed and the ejector 116 will eject material at a thickness greater than the target thickness. As an alternative speed control, the controller 138 may directly set the speed of the engine 124 and the gear/speed ratio of the transmission 126, thereby preventing the ADT 100 from going over or under the control speed and leaving the operator to control just the speed of the ejector 116 (via actuation of the lever 134) during the unloading process. As another alternative speed control, the controller 138 may set the gear/speed ratio of the transmission 126 and allow the operator to control the speed, torque, or power of the engine 124, thereby limiting the speed of the ADT 100 to a speed associated with that gear/speed ratio and the maximum speed of the engine 124, but not ensuring that the ADT 100 reaches that speed. As another alternative speed control, the controller 138 may limit the speed of the engine 124 and selectively engage a retarder if the ADT 100 exceeds the control speed, thereby preventing the speed of the ADT 100 from exceeding the control speed when there is an overrunning load on the powertrain, which may result if the ADT 100 is unloading while traveling down a steep incline.

The thickness at which material in the bin 110 is spread depends on the distribution of material in the bin 110, the speed at which the ejector 116 is operating and moving material out of the bin 110, and the ground speed of the ADT 100. In many operations, the distribution of material in the bin 110 is a given variable by the time the ADT 100 is ready to begin the unloading process, and cannot be controlled, so control of the thickness at which material is spread depends on control of the other two variables or sensing of one of the two variables and control of the other variable based on the sensed variable. In the control system 200, the controller 138 receives the commanded speed of the ejector 116 and controls the ground speed of the ADT 100 in order to control the thickness at which material is spread. In alternative embodiments, sensors may be installed and configured to determine the distribution of material in the bin 110, and this information may be used to refine the control of the speed of the ADT 100 to more closely achieve the target thickness for uneven distributions in the bin 110.

In order to the determine the controlled speed of the ADT 100 for step 208, the controller 138 determines the speed of the ejector 116 based on the ejection command received in step 206, correlates that speed with an ejection rate, and determines the controlled speed based on that ejection rate and the target thickness.

The speed of the ejector 116 is dependent on a number of factors, including the flow rate of hydraulic fluid into the actuator 118 (which in turn depends on the state of the electro-hydraulic valve 120, the speed and displacement of the hydraulic pump 122, and any other hydraulic components using flow from the hydraulic pump 122 at the same time) and the effective hydraulic area of the actuator 118 (e.g., the area being swept by extension of the actuator 118) and can be determined in a number of ways known in the art based on these or other factors. The determination of the speed of the ejector 116 may need to account for a varying effective area if the actuator 118 is a telescoping cylinder, as a constant flow of hydraulic fluid will result in a different speed for the ejector 116 for each telescoping stage of the actuator 118. The length of the actuator 118 may need to be sensed either directly, or indirectly by sensing the position of the ejector 116, in order to determine which stage of the actuator 118 is currently active in order to determine the current effective area of the actuator 118. Alternatively, rather than estimating the speed of the ejector 116 based on such factors, the speed may be estimated by correlating the ejection command with a speed based on previously gathered empirical data or by measuring the actual speed of the ejector 116 (either directly or by differentiating a position measurement).

The controller 138 can next correlate the speed of the ejector 116 with an ejection rate of material out of the bin 110. There are multiple approaches to determining this correlation. As an example, the effective cross sectional area of the bin 110 can be stored in the controller 138, and this cross sectional area can be multiplied by the speed of the ejector 116 to arrive at a volumetric material ejection rate. As another example, this calculation may be simplified to two dimensions (which may be appropriate if the width of material unloaded and the internal width of the bin 110 are similar) if the effective height of the material in the bin 110 is stored in the controller 138 and multiplied by the speed of the ejector 116 to arrive at an ejection rate. These effective cross-sectional areas and effective heights can also be adjusted to account for incomplete loads. For example, the weight of the payload may be sensed and compared to a default weight when the bin 110 is full, and then the effective cross-sectional area and effective height can be adjusted accordingly such that a 75% full bin 110 results in 75% of the effective cross-sectional area or 75% of the effective height. As another example, the weight of the payload and the estimated material density may be utilized to estimate the volume of the load in the bin 110. As another example, an optical, radio, or other sensor may be configured to observe the interior of the bin 110 and estimate the volume, height, and/or distribution of material within the bin 110. As another example, empirical, modeled, or calculated data on the material ejection rates for various speeds of the ejector 116 may be gathered and used, such as in a look-up table, to correlate the ejection rate with a speed of the ejector 116. As yet another example, the material flowing out the back of the bin 110 may be directly sensed, such as by an optical, radio, or other sensor, and this material flow rate may be used to control the speed of the ejector 116 or the vehicle 100.

The controller 138 then uses the ejection rate to control the speed of the ADT 100. If a volumetric ejection rate was determined, then the rate may be divided by the width over which the material is spread out the back of the bin 110 and the target thickness to find the control speed for the ADT 100. If the material ejection rate was determined in two dimensions, then the rate may be divided by the target thickness to find the control speed for the ADT 100. Depending on the configuration and state of the ADT 100, this calculation may be complicated if the speed of the ejector 116 is dependent on the speed of the engine 124. For example, the speed of the ejector 116 may increase as the rotational speed of the hydraulic pump 122 increases along with the speed of the engine 124. This dependency can be addressed in multiple ways. As one way, the controller 138 can loop through steps 206, 208, and 210 until the proper ratio of the speed of the ADT 100 to the speed of the ejector 116 is reached. As another way, the controller 138 can utilize known relationships between the speed of the engine 124, the gear/speed ratio of the transmission 126, the speed of the ejector 116, and the speed of the ADT 100 to select a speed of the engine 124 and a gear/speed ratio of the transmission 126 at which the ejector speed 116 and the speed of the ADT 100 result in the target thickness, and command that speed for the engine 124 and that gear/speed ratio for the transmission 126.

As an alternative to the above calculations, the correlation between the speed of the ejector 116 and the thickness of the material unloaded by the ADT 100 may be pre-calculated and stored on, or made accessible to, the controller 138. Empirical, modeled, or calculated data on the thickness which results from various combinations of the speed of the ADT 100 and the ejector 116 may be stored on, or made accessible to, the controller 138, such as in a look-up table. The controller 138 may then look up the appropriate speed of the ADT 100 using the target thickness and the speed of the ejector 116. Once the control speed for the ADT 100 is determined in step 208, the controller 138 utilizes it to control the speed of the ADT 100 by controlling the engine 124, the transmission 126, a retarder, an engine brake, or service brakes. While the speed of the ADT 100 relative to the speed of the ejector 116 is referenced above, it would be equivalent in many regards to reference the speed of the ADT 100 relative to the ejection command, with the ejection command being adjusted according to other operating parameters (e.g., speed of the engine 124, gear/speed ratio of the transmission 126) or with the ejection command being used in a look-up table associating ejection command, speed of the ADT 100, and target thickness.

After controlling the speed of the ADT 100 in step 208, the controller 138 then performs step 210 and determines whether the bed or the bin 110 of the ADT 100 is empty. The controller 138 determines the load state of the bin 110 by sensing the position of the ejector 116 and determining whether it has reached the end of its travel, at which point the bin 110 is empty. Alternatively, the controller 138 could receive a signal from a payload weighing system indicative of the payload in the bin 110, and could determine that the bin 110 is empty when that payload weight falls below a threshold. As another alternative, if the controller 138 lacks signals directly indicative of the position of the ejector 116, it could estimate its position such as by tracking the hydraulic flow into the actuator 118 and determining when that flow exceeds a threshold which suggests that the actuator 118 should be fully extended and the bin 110 is empty. As another alternative, the controller 138 may receive signals indicative of a pressure of the electro-hydraulic valve 120 or the actuator 118 and determine that the bin 110 is empty when the pressure rises above a threshold, indicating that the ejector 116 or the actuator 118 have reached an end-of-travel stop.

If the bin 110 is not empty, the controller 138 loops back to step 206 and will continue monitoring the ejection command and controlling the speed of the ADT 100 based on the ejection command (and the speed of the ejector 116) to unload material at the target thickness. If the bin 110 is empty, the controller 138 proceeds to step 212. Alternatively, the control system 200 may also exit the loop of steps 206, 208, and 210 and proceed to step 212 upon the occurrence of a canceling event, such as the movement of the lever 134 into a position indicative of a command to retract the ejector 116, the actuation of a brake pedal, or the actuation of a switch such as switch 136. In step 212, the controller 138 ceases to control the speed of the ADT 100 and exits the ejection mode of steps 206, 208, and 210, and then proceeds to step 204, where it awaits an ejection initiation and re-entry into the ejection mode.

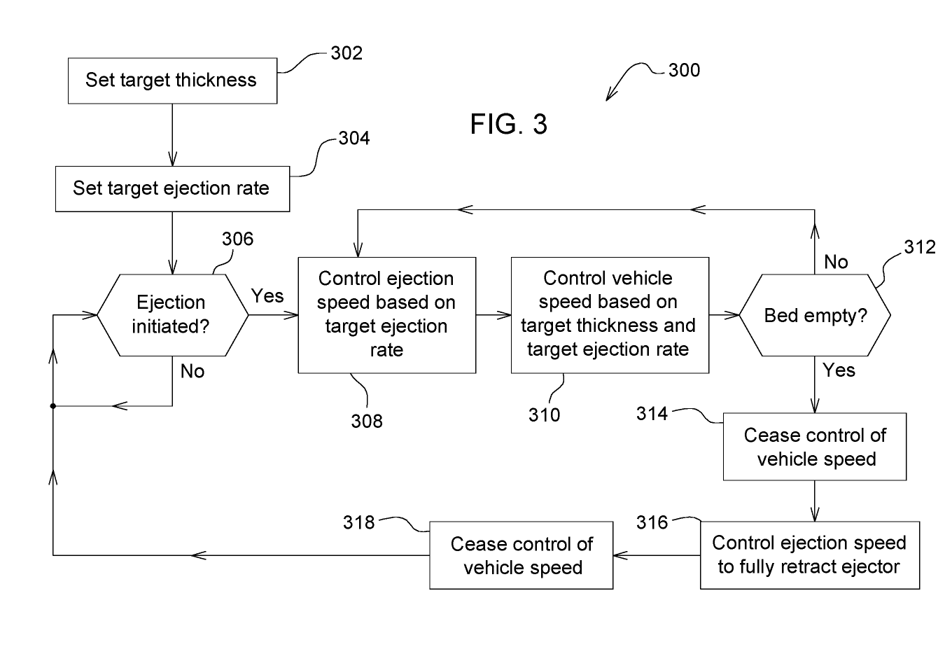

FIG. 3 illustrates a flowchart of an alternate control system 300 that the controller 138 may execute in order to spread material at an unloading area based on a target ejection rate and a target thickness. In step 302, the controller 138 sets a target thickness. In step 304, the controller 138 sets a target ejection rate indicative of a target rate for the ejection of material from the bin 110. The target ejection rate may be expressed as a value with units such as cubic meters or percent of the bin 110 per second. Similar to the target thickness, the target ejection rate may be set based on a signal received from the monitor 132 after the operator has entered a target ejection rate or a signal received from a remote server. In step 306, the controller 138 determines whether an ejection has been initiated such that an ejection mode consisting of steps 308, 310, 312, 314, 316, and 318 should be entered. If an ejection has not been initiated, the controller 138 may loop through step 306 until an ejection is initiated.

If an ejection is initiated, the controller 138 performs step 308 next where it controls the speed of the ejector 116 based on the target ejection rate. Controller 138 may perform step 308 by commanding the electro-hydraulic valve 120 so that the ejector 116 extends rearwards and ejects material at the target ejection rate. The controller 138 may determine a target speed for the ejector 116 based on the target ejection rate, and then utilize further calculations to determine the proper command to send to the electro-hydraulic valve 120 to achieve the target speed for the ejector 116. These further calculations may include taking into account the rotational speed and displacement of the hydraulic pump 122, the pressure provided by the hydraulic pump 122 to the electro-hydraulic valve 120, other hydraulic components utilizing flow from the hydraulic pump 122, the current stage of the actuator 118 if it is a telescoping cylinder, and the relationship between command and hydraulic flow for the electro-hydraulic valve 120, among other potential variables. As an alternative to these calculations, a look-up table or other data utilizing one or more input variables to correlate the command to the electro-hydraulic valve 120 to the speed of the ejector 116 may be utilized.

As one example, if the target ejection rate is 10% per second, the controller 138 may command the electro-hydraulic valve 120 so that the ejector 116 moves at a velocity for which it will take 10 seconds to reach the end of travel and empty the bin 110. As another example, if the target ejection rate is 2 cubic meters per second, and the effective cross-sectional area of the bin 110 at its rearward end is 2 square meters, then the controller 138 commands the ejector 116 to travel at 1 meter per second to achieve the target ejection rate. Alternatively, empirical, modeled, or calculated data on the material ejection rates for various speeds of the ejector 116 may be gathered and used, such as in a look-up table, to correlate a target ejection rate with a speed of the ejector 116.

After the controller 138 has controlled the speed of the ejector 116 in step 308, it controls the speed of the ADT 100 in step 310 based on the target thickness and the target ejection rate set in steps 302 and 304, respectively. Similar to step 206 of the control system 200, in step 310 the controller 138 determines a speed of the ADT 100 which will result in the target thickness. This can be calculated in multiple ways. As one example, the target ejection rate (e.g., 2 cubic meters per second) can be divided by the product of the effective cross-sectional area at the rear of the bin 110 (e.g., 2 square meters) and the target thickness (e.g., 0.5 meters) to determine a control speed (e.g., 2 meters per second). As another example, this calculation could be simplified into two dimensions by dividing the target speed of the ejector 116 (e.g., 1 meter per second) by the target thickness (e.g., 0.5 meters) to determine a control speed (e.g., 2 meters per second).

After the controller 138 has controlled the speed of the ADT 100 in step 310, it proceeds to step 312 where it determines whether the bed/bin 110 is empty. If no, it loops through steps 308, 310, and 312. If the bin 110 is empty, it proceeds to step 314 where it ceases to control the speed of the ADT 100, then to step 316.

At step 316, which is an optional step which may be added or removed from embodiments of the present disclosure, the controller 138 commands the ejector 116 to retract until it reaches its fully retracted position toward the forward end of the ejector body 108. This step automates the process of returning the ejection system 114 and the bin 110 into a ready-to-load state. After step 316, the controller 138 performs step 318 where it ceases to control the speed of the ejector 116. Like with the control system 200, the control system 300 may permit a transition directly to step 306 upon the occurrence of a canceling event, such as the actuation of the lever 134, a brake pedal, or a switch such as switch 136.

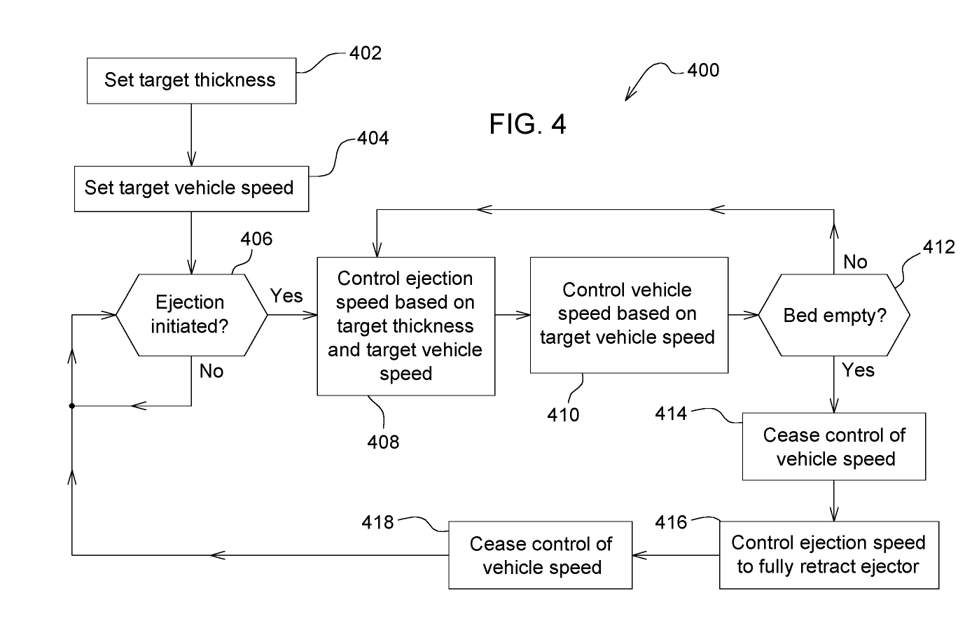

FIG. 4 illustrates a flowchart of an alternate control system 400 that the controller 138 may execute in order to spread material at an unloading area based on a target thickness and a target vehicle speed. In step 402, the target thickness may be set by the controller 138 and in step 404, the target vehicle speed may be set based on inputs actuated by an operator or inputs from other controllers, located either on the ADT 100 or remote from the ADT 100. In step 406, the controller 138 will determine if an ejection is initiated and will loop step 406 if it has not, and proceed to step 408 if it has.

In step 408, the controller 138 controls the speed of the ejector 116 based on the target thickness and the target vehicle speed. As one example, the controller 138 may determine this speed by utilizing a ratio of the speed of the ejector 116 to the speed of the ADT 100, with the ratio based on the effective cross-sectional area at the rear of the bin 110. As another example, the controller 138 may determine the speed of the ejector 116 by utilizing data correlating the speed of the ADT 100, the speed of the ejector 116, and the thickness of material unloaded, such as data stored in a look-up table stored or accessible by the controller 138. After step 408, the controller 138 executes step 410 where it controls the speed of the ADT 100 and then step 412, where it determines whether to loop steps 408, 410, and 412 if the bin 110 is not empty, or proceed to step 414 if the bin 110 is empty. In step 414, the controller 138 ceases controlling the speed of the ADT 100, then proceeds to step 416 where it retracts the ejector 116 to its fully retracted position and then step 418 where it ceases control of the ejector 116.

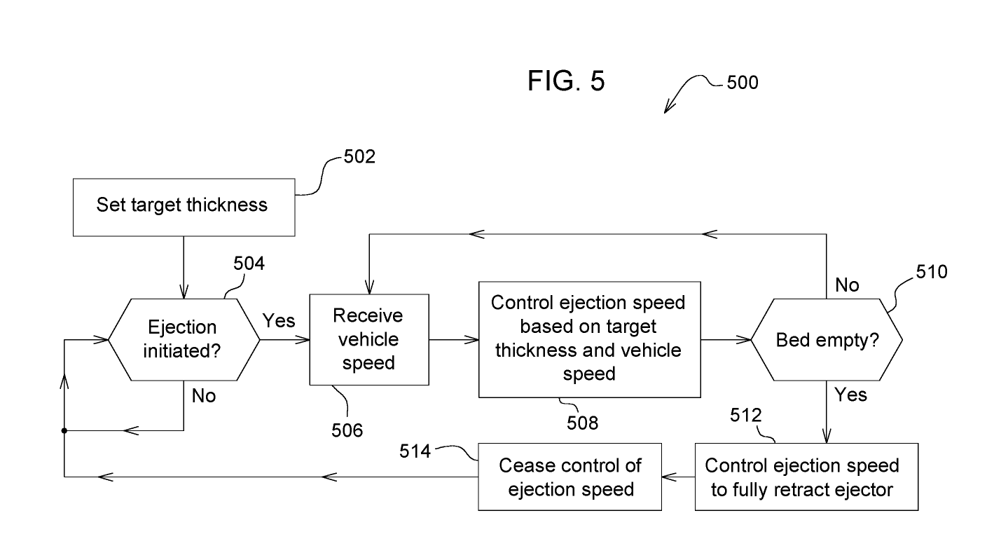

FIG. 5 illustrates a flowchart of an alternate control system 500 that the controller 138 may execute in order to spread material at an unloading area based on a target thickness. In step 502, the controller 138 receives a target thickness, then proceeds to step 504 where it determines whether an ejection has been initiated. In this embodiment, the controller 138 senses whether the operator has actuated the switch 136 in order to initiate an ejection and transition into an ejection mode. If the operator has actuated the switch 136, the controller 138 proceeds to step 506. If the operator has not actuated the switch 136, the controller 138 loops through step 504 until it receives a signal from the switch 136. In step 506, the controller 138 receives the speed signal from the vehicle speed sensor 130 and then proceeds to step 508.

In step 508, the controller 138 uses the target thickness set in step 502 and the vehicle speed received in step 506 to control the speed of the ejector 116 to achieve the target thickness. The control system 500 is similar to the control system 200, except that while control system 200 receives a speed of the ejector 116 and controls the speed of the ADT 100 to achieve the target thickness, control system 500 receives the speed of the ADT 100 and controls the speed of the ejector 116 to achieve the target thickness. However, the control system 500 also includes step 512, where the controller 138 retracts the ejector 116 after the unloading process is complete and before exiting the ejection mode after step 514.

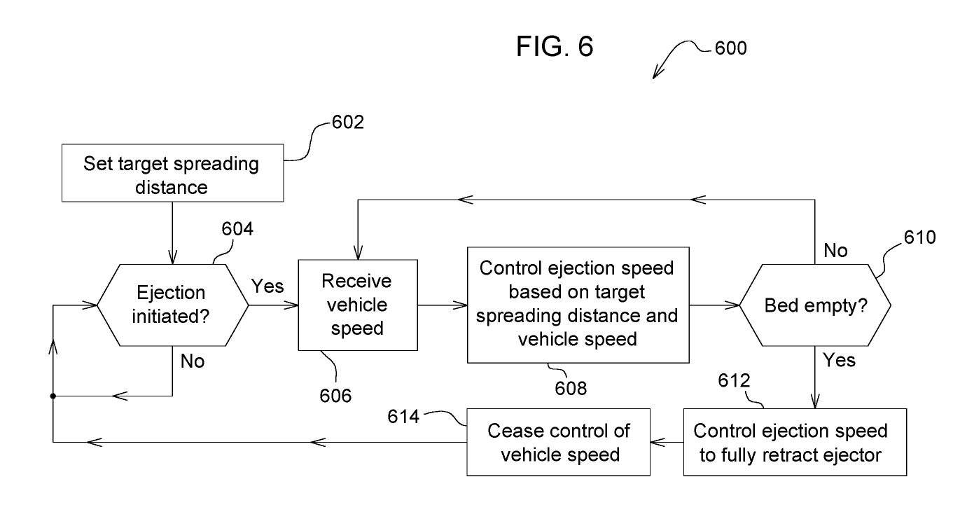

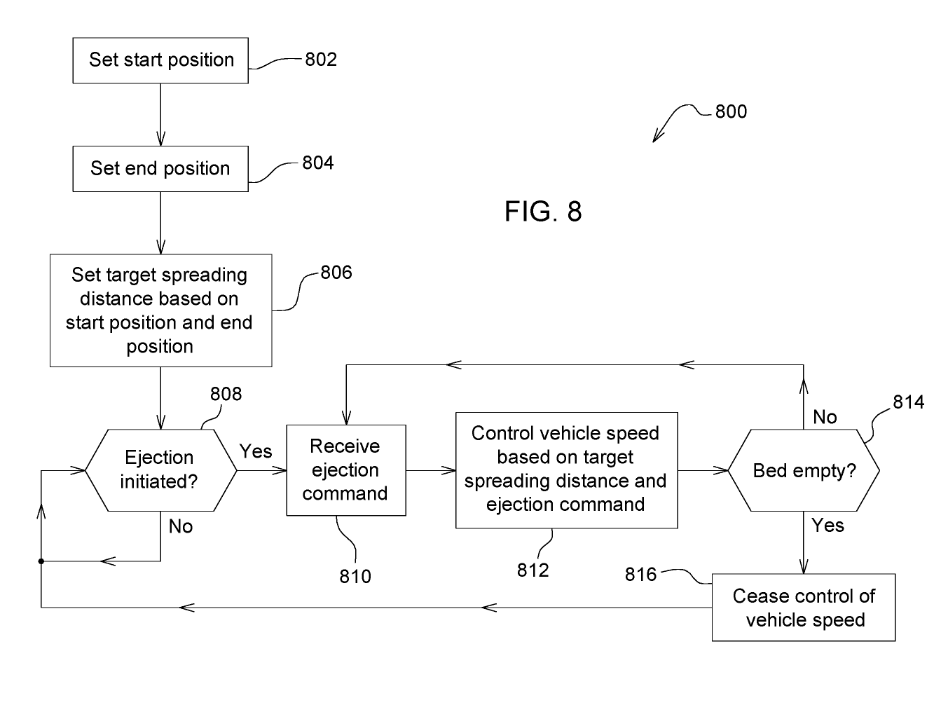

FIG. 6 illustrates a flowchart of an alternate control system 600 that the controller 138 may execute in order to spread material at an unloading area based on a target spreading distance by controlling the speed of the ejector 116. In step 602, the controller 138 sets a target spreading distance. The controller 138 may set the target spreading distance based on a signal received from an input actuated by an operator of the ADT 100, such as a value entered into the monitor 132. As an alternative, the controller 138 may set the target spreading distance based on an indicated start position and an indicated end position, as is described further with regard to FIG. 8. As another alternative, the controller 138 may set the target spreading distance based on a communication from another control system running on the controller 138, another controller on the ADT 100 (e.g., one executing a grade control system or site planning system), or a signal from a remote controller, server, owner, operator, site manager, fleet manager, or other work vehicle at the work site.

In step 604, the controller 138 determines whether an ejection has been initiated, loops step 604 if it has not been initiated, and proceeds to step 606 if it has been initiated. In step 606, the controller 138 receives the speed of the ADT 100 and then proceeds to step 608.

In step 608, the controller 138 controls the speed of the ejector 116 based on the target spreading distance set in step 602 and the speed of the ADT 100 received in step 606. There are multiple ways in which the controller 138 can perform this control. As one example, the controller 138 can divide the target spreading distance (e.g., 50 meters) by the speed of the ADT 100 (e.g., 5 meters per second) to find a cycle time for the ejector 116 (e.g., 10 seconds), and can control the speed of the ejector 116 to match that cycle time (e.g., 0.5 meters per second if the stroke length for the actuator 118 is 5 meters). As another example, empirical, modeled, or calculated data can be used to determine the speed of the ejector 116 necessary to meet a target spreading distance when given a speed of the ADT 100.

After step 608, the controller 138 proceeds to step 610 where it determines whether the bin 110 is empty, repeating steps 606, 608, and 610 if it is not empty, and proceeding to step 612 if it is empty. In step 612, the controller 138 retracts the ejector 116, then proceeds to step 614 where it ceases control of the speed of the ejector 116, before returning to step 604 to await the next entry into the ejection mode.

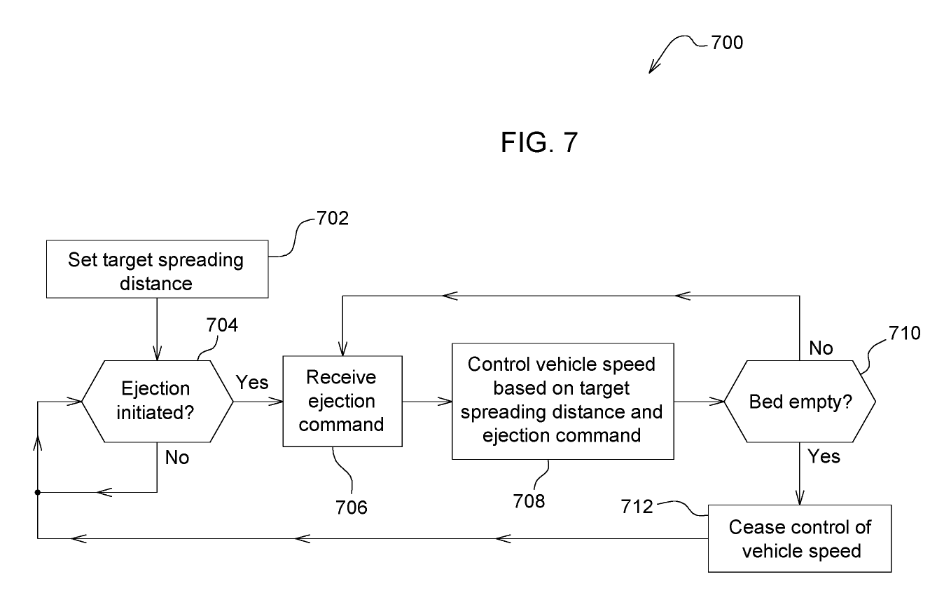

FIG. 7 illustrates a flowchart of an alternate control system 700 that the controller 138 may execute in order to spread material at an unloading area based on a target spreading distance by controlling the speed of the ADT 100. The control system 700 is similar in many regards to the control system 600, except that the control system 600 senses the speed of the ADT 100 and controls the speed of the ejector 116 to meet the target spreading distance, while the control system 700 senses the ejection command or speed of the ejector 116 and controls the speed of the ADT 100 to meet the target spreading distance.

FIG. 8 illustrates a flowchart of an alternate control system 800 that the controller 138 may execute in order to spread material at an unloading area based on a target spreading distance which is set based on a start position and an end position. In step 802, the controller 138 sets a start position of the ADT 100. The controller 138 sets this start position by storing the position of the ADT 100 when the operator actuates the switch 136, for example by storing the position indicated by a positioning signal received by the controller 138 from a GNSS or local positioning system. Alternatively, the controller 138 may set this start position based on another input indicative of the start position, such as input on the monitor 132 or other operator input, input from another program being executed by the controller 138, input from another controller on the ADT 100 (e.g., one executing a grade control system or site planning system), or input from a remote server, controller, owner, operator, fleet manager, or site manager. Some of these alternatives may send a signal to record the current position of the ADT 100 for the start position, while others, such as a remote server, may send the start position to the controller 138.

In step 804, the controller 138 sets an end position of the ADT 100. The end position may be set in the same manner as the start position, by recording the current position of the ADT 100 when the operator actuates the switch 136, or via any of the alternatives described above. In this way, the control system 800 stores the position of the ADT 100 as the start position upon the first actuation of the switch 136 and stores the position of the ADT 100 as the end position upon the second actuation of the switch 136. As another alternative, the operator may actuate switch 136 to store the start position and a second switch may be provided for the operator to actuate to store the end position. As another alternative, the operator may press and hold the switch 136, drive ADT 100 a distance, then release the switch 136, and the control system may store the start position as the position of the ADT 100 when the switch was depressed, and the end position as the position of the ADT 100 when the switch was released. As another alternative, the control system may store the start position as the position of the ADT 100 when the switch 136 is actuated for less than a period of time, and may store the end position as the position of the ADT 100 when the switch 136 is actuated for more than a period of time.

In step 806, the controller 138 sets the target spreading distance based on the start position set in step 802 and the end position set in step 804. The controller 138 does this by calculating the distance between the start position and the end position, and storing this difference as the target spreading distance. After determining the target spreading distance, the controller proceeds to steps 808, 810, 812, 814, and 816. These steps in the control system 800 are the same as the equivalent steps in the control system 700, except that they are using a target spreading distance which was set by the controller 138 based on start and end positions instead of a target spreading distance which was directly communicated to or set by the controller 138.

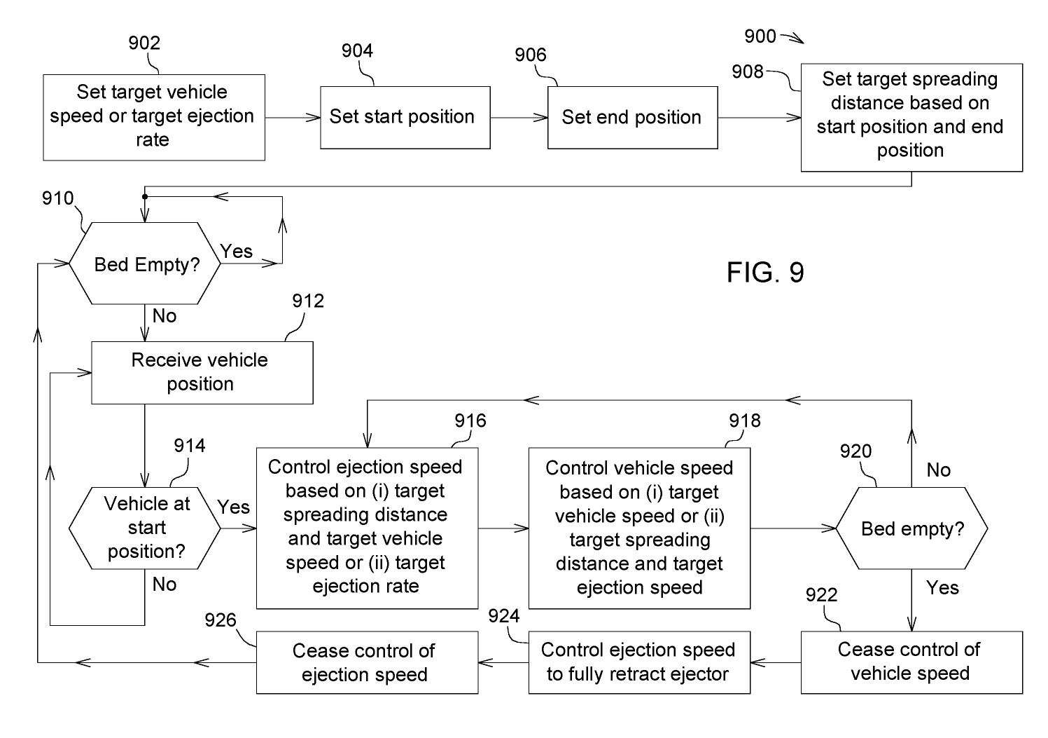

FIG. 9 illustrates a flowchart of an alternate control system 900 that the controller 138 may execute in order to automatically initiate the spreading of material at an unloading area based on a set start and end position and a target vehicle speed or target ejection rate. In step 902, the controller 138 sets the target vehicle speed or the target ejection rate. Either target may be set in a manner similar to at least one of those described for the control system 300 and the control system 400, or may be directly set such as by the operator or a remote fleet or site manager setting such targets. In steps 904, 906, and 908, the controller 138 may set the start position, end position, and target spreading distance in a manner similar to at least one of those described for steps 802, 804, and 806 for the control system 800. In step 910, the controller 138 determines whether the bed or the bin 110 of the ADT 100 is empty. This optional step may be used to avoid an unloading cycle if the ADT 100 approaches the unloading area without a load in its bin 110. If the bin 110 is empty, the control system 900 loops through step 910 until the bin 110 is not empty. Once the bin 110 is not empty, the controller 138 executes step 912. In step 912, the controller 138 receives the position of the ADT 100, such as the position indicated by a signal received from a positioning system such as a GNSS, a local position system, an inertial positioning system, or other positioning system such as a hybrid positioning system.

In step 914, the controller 138 determines whether the ADT 100 is at the start position. For step 914, the determination of whether the ADT 100 is at the start position may include determining whether the ADT 100 is within a zone or area based on the start position set in step 904. As one example, it could be the circular area within 10 meters of the start position set in step 904. As another example, it could be another shape such as a rectangle which broadens the area around the start position set in step 904 more in one dimension than another. As another example, it could be a line of a certain distance extending through the start position set in step 904, where the controller 138 determines that the ADT 100 is at the start position as long as it crosses that line. If the ADT 100 is not at the start position, the control system 900 may loop back to step 912 and the controller may repeat steps 912 and 914 until the ADT 100 is at the start position. If the controller 138 determines that the ADT 100 is at the start position, it may initiate an ejection or unloading process by proceeding to step 916 and entering an ejection mode.

In alternate embodiments, step 914 may involve controlling the speed of the ADT 100 as it approaches the start position or area around the start position. In these alternates, the controller 138 may determine the proximity of the ADT 100 to the start position and control the speed, such as by setting or reducing the maximum speed, based on such proximity such that the ADT 100 achieves the target vehicle speed or a suitable speed for unloading by the time it begins the unloading process. As one example, the controller 138 may reduce the maximum speed of the ADT 100 to the target vehicle speed once the ADT 100 is within 50 meters of the start position, and enter the ejection mode once the ADT 100 is within 5 meters of the start position. As another example, the controller 138 may reduce the maximum speed of the ADT 100 to 20 kilometers per hour when within 50 meters of the start position and further reduce the maximum speed of the ADT 100 to 10 kilometers per hour when within 10 meters of the start position and throughout the ejection mode.

In step 916, the controller 138 controls the speed of the ejector 116 based on (i) the target spreading distance and the target vehicle speed or (ii) the target ejection rate. If a target vehicle speed was set in step 902, the controller 138 controls the speed of the ejector 116 in a manner similar to at least one of those described for step 608 of the control system 600. If a target ejection rate was set in step 902, the controller 138 controls the speed of the ejector 116 based on the target ejection rate in a manner similar to at least one of those described for step 308 of the control system 300. Next, in step 918, the controller 138 controls the speed of the ADT 100 based on (i) the target vehicle speed or (ii) the target spreading distance and ejection speed. If a target vehicle speed was set in step 902, the controller 138 controls the speed of the ADT 100 based on that speed. If a target ejection rate was set in step 902, the controller 138 controls the speed of the ADT 100 based on the targets spreading distance set in step 908 and the ejection speed of step 916 in a manner similar to at least one of those described for step 708 of the control system 700. In step 920, the controller 138 determines whether the bin 110 is empty. If not, the controller 138 loops through steps 916, 918, and 920. If bin 110 is empty, the controller 138 proceeds to steps 922, 924, and 926 where it ceases controlling of vehicle speed, retracts the ejector 116, and ceases control of the ejection speed, in a manner similar to at least one of those described for steps 314, 316, and 318 of the control system 300. The control system 900 may thereby initiate an unloading cycle, control both the ejection speed and the vehicle speed of the ADT 100 for the unloading cycle, and end the unloading cycle automatically.

The control system 900 illustrates a return to step 910 after the completion of step 926. In alternative embodiments, the operator may provide an input to return to step 902 if a change to any of the target vehicle speed, target ejection rate, start position, end position, or target spreading distance is desired. In alternate embodiments, the control system 900 may allow for the direct setting of the target spreading distance instead of proceeding through steps 904, 906, and 908. In other alternate embodiments, the control system 900 may be modified to utilize a target thickness instead of a target spreading distance.

The contents of U.S. application Ser. No. ______ (attorney docket number P23419-US, “Ejector control for spreading material according to a profile”), filed on the same day herewith, is hereby incorporated by reference herein.

Without in any way limiting the scope, interpretation, or application of the claims appearing below, a technical effect of one or more of the example embodiments disclosed herein is to provide or use a work vehicle with an ejector body to unload material across a desired distance or at a desired thickness in an automated or semi-automated manner. Another technical effect of one or more of the example embodiments disclosed herein is to provide or use a work vehicle with an ejector body to begin an unloading cycle at a certain position. Another technical effect of one or more of the example embodiments disclosed herein is to provide or use a work vehicle with an ejector body to unload material across a desired distance or at a desired thickness in an automated or semi-automated manner utilizing certain set parameters, such as target vehicle speeds, target ejection speeds, and target ejection rates.

As used herein, “controller” is intended to be used consistent with how the term is used by a person of skill in the art, and refers to a computing component or a collection of computing components with processing, memory, and communication capabilities which is utilized to control one or more other components. In certain embodiments, a controller may also be referred to as a control unit, vehicle control unit (VCU), engine control unit (ECU), transmission control unit (TCU), or hydraulic, electrical or electro-hydraulic controller. In certain embodiments, a controller may be configured to receive input signals in various formats (e.g., hydraulic signals, voltage signals, current signals, CAN messages, optical signals, radio signals), and to output command signals in various formats (e.g., hydraulic signals, voltage signals, current signals, CAN messages, optical signals, radio signals). Unless described otherwise, the term “controller” is intended to mean both a signal controller and a collection of cooperating controllers.

Embodiments of the present disclosure may be described herein in terms of logical block components and various steps, including in flow charts. It should be appreciated that such block components and steps may be realized by any number of appropriately-configured hardware, software, and/or firmware components. For example, an embodiment of the present disclosure may employ various integrated circuit components (e.g., memory elements, digital signal processing elements, logic elements, look-up tables) which may carry out a variety of logic and steps under the control of one or more microprocessors or other control devices. In addition, those skilled in the art will appreciate that embodiments of the present disclosure may be practiced in conjunction with any number of systems, and that the ADT 100 described herein is merely one exemplary embodiment of the present disclosure. Further, although certain embodiments of the disclosure are illustrated as a flowchart, the disclosure is not limited to such steps and the order of steps of presented, and it would be well within the skill of one of ordinary skill in the art to reorder, combine, or split many of the steps and achieve the same result.

As used herein, “e.g.” is utilized to non-exhaustively list examples, and carries the same meaning as alternative illustrative phrases such as “including,” “including, but not limited to,” and “including without limitation.”

As used herein, unless otherwise limited or modified, lists with elements that are separated by conjunctive terms (e.g., “and”) and that are also preceded by the phrase “one or more of,” “at least one of,” “at least,” or a like phrase, indicate configurations or arrangements that potentially include individual elements of the list, or any combination thereof. For example, “at least one of A, B, and C” and “one or more of A, B, and C” each indicate the possibility of only A, only B, only C, or any combination of two or more of A, B, and C (A and B; A and C; B and C; or A, B, and C).

As used herein, the singular forms “a”, “an” and “the” are intended to include the plural forms as well, unless the context clearly indicates otherwise. Further, “comprises,” “includes,” and like phrases are intended to specify the presence of stated features, steps, operations, elements, and/or components, but do not preclude the presence or addition of one or more other features, steps, operations, elements, components, and/or groups thereof

For the sake of brevity, conventional techniques and arrangements related to signal processing, data transmission, signaling, control, and other aspects of the systems disclosed herein may not be described in detail. Furthermore, the connecting lines shown in the various figures contained herein are intended to represent example relationships and/or connections between the various elements (e.g., electrical power connections, communications, physical couplings). It should be noted that many alternative or additional relationships or connections may be present in an embodiment of the present disclosure.

While the present disclosure has been illustrated and described in detail in the drawings and foregoing description, such illustration and description is not restrictive in character, it being understood that illustrative embodiment(s) have been shown and described and that all changes and modifications that come within the spirit of the present disclosure are desired to be protected. Alternative embodiments of the present disclosure may not include all of the features described yet still benefit from at least some of the advantages of such features. Those of ordinary skill in the art may devise their own implementations that incorporate one or more of the features of the present disclosure and fall within the spirit and scope of the appended claims.

1: A method of operating a work vehicle with an ejector body, the method comprising the steps of:
receiving a target parameter at a controller, the target parameter indicative of at least one of a target distance over which to spread a load of material from the ejector body onto a ground surface and a target thickness at which to spread the material from the ejector body onto the ground surface;
entering a controller into an ejection mode; and
controlling, with the controller, in the ejection mode, at least one of a speed of the work vehicle and a speed of an ejector included in the ejector body, the ejector movable from a retracted position to an extended position to eject material from the ejector body onto the ground surface, to spread the material based on the target parameter onto the ground surface with the ejector.

2: The method of claim 1, wherein the speed of the work vehicle is controlled based on the target distance and the speed of the ejector.

3: The method of claim 1, wherein the speed of the ejector is controlled based on the target distance and the speed of the work vehicle.

4: The method of claim 1, wherein the speed of the work vehicle is controlled based on the target thickness and the speed of the ejector.

5: The method of claim 1, wherein the speed of the ejector is controlled based on the target thickness and the speed of the work vehicle.

6: The method of claim 1, wherein the controller is entered into the ejection mode based on an ejection command received from an input actuated by an operator of the work vehicle.

7: The method of claim 1, further comprising the steps of:
receiving a position signal indicative of a position of the work vehicle;
determining a first position based on the position signal upon receiving a first input from an operator of the work vehicle;
determining a second position based on the position signal upon receiving a second input from the operator of the work vehicle; and
determining the target parameter based on a comparison of the first position and the second position.

8: The method of claim 1, further comprising the step of receiving a position signal indicative of a position of the work vehicle, wherein the controller is entered into the ejection mode based on a comparison of the position signal and a first position.

9: The method of claim 8, further comprising the steps of:
determining the first position based on the position signal upon receiving a first input from an operator of the work vehicle;
determining a second position based on the position signal upon receiving a second input from the operator of the work vehicle; and
determining the target parameter based on a comparison of the first position and the second position.

10: The method of claim 8, further comprising the step of limiting a maximum speed of the work vehicle, prior to entering the controller into the ejection mode, based on a comparison of the position signal and the first position.

11: The method of claim 10, wherein the maximum speed is based on the target parameter.

12: A work vehicle with an ejector body comprising: an engine;
a transmission;
an ejector connected to the ejector body and movable by an actuator at an ejector speed from a retracted position and an extended position to eject material from the ejector body onto a ground surface; and
a controller configured to:
receive a target parameter indicative of at least one of a target distance and a target spreading thickness;
receive a speed signal indicative of a speed of the work vehicle;
enter an ejection mode; and
control, in the ejection mode, at least one of a speed of the engine, a gear selection of the transmission, and the ejector speed based on the target parameter to spread a load of material from the ejector body onto the ground surface with the ejector.

13: The work vehicle of claim 12, further comprising:
a first operator input configured to provide the target parameter;
a second operator input configured to provide an ejection command when actuated; and
a vehicle speed sensor configured to provide the speed signal;
wherein the controller is further configured to receive the ejection command and enter the ejection mode based on the ejection command.

14: The work vehicle of claim 12, wherein the controller is further configured to control, in the ejection mode, the ejector speed based on the target parameter and the speed signal.

15: The work vehicle of claim 12, wherein the controller is further configured to control, in the ejection mode, the speed of the engine based on the target parameter.

16: The work vehicle of claim 12, further comprising a positioning system receiver configured to provide a position signal indicative of a position of the work vehicle, wherein the controller is further configured to:
receive the position signal; and
enter the ejection mode based on a comparison of the position signal and a first position.

17: The work vehicle of claim 13, further comprising a positioning system receiver configured to provide a position signal indicative of a position of the work vehicle, wherein the controller is further configured to:
receive the position signal;
determine the first position based on the position signal when the second operator input is actuated and held for a period of time; and
enter the ejection mode based on a comparison of the position signal and a first position.

18: The work vehicle of claim 13, further comprising a positioning system receiver configured to provide a position signal indicative of a position of the work vehicle, wherein the controller is further configured to:
receive the position signal;
determine a first position based on the position signal and a first actuation of the second operator input;
determine a second position based on the position signal and a second actuation of the second operator input; and
determine the target parameter based on a comparison of the first position and the second position.

19: The work vehicle of claim 18, wherein the controller enters the ejection mode upon receiving the ejection command for less than a period of time, the first actuation is actuating the second operator input from a neutral position to a depressed position for at least the period of time, and the second actuation is actuating, after the first actuation, the second operator input from a neutral position to a depressed position for at least the period of time.

20: The work vehicle of claim 18, wherein the controller enters the ejection mode upon receiving the ejection command for less than a period of time, the first actuation is actuating the second operator input from a neutral position to a depressed position for at least the period of time, and the second actuation is actuating the second operator input from the depressed position to the neutral position after the first actuation.
